(19) United States
(12) Patent Application Publication
(10) Pub. No.: US 2004/0042530 A1
(43) Pub. Date: Mar. 4, 2004

(54) Code-select cdma modulation/demodulation method and device thereof

(76) Inventor: Seung-Moon Ryu, Gyeongi-do (KR)

Correspondence Address: Coleman Sudol Sapone, 714 Colorado Avenue, Bridgeport, CT, 06605-1601, US

(21) Appl. No.: 10/433,591

(22) PCT Filed: May 1, 2002
(86) PCT No.: PCT/KR02/00814

(30) Foreign Application Priority Data
Oct. 8, 2001 (KR) 2001/0061738

(51) Int. Cl. H04B 1/707

(52) U.S. Cl. 375/141

(57) ABSTRACT

The present invention, relevant to a procedure for modulating/demodulating with code-select/code-division multiple access, provides a technique of code-division multiple-access, in which information channels in number of N+1 are assigned to each of blocks that includes a unit of orthogonal signature pattern codes in number of 2^{N}, which are generated to maintain orthogonality between information channels transferred. One of the orthogonal codes of 2N belonging to the block is selected as a digital bit value of N-numbered information channels among the assigned information channels, and the other digital bit value of the information channel is set by modulating data channels of N+1 after being multiplied by the selected orthogonal code. Therefore, it reduces the number of orthogonal codes to be transferred rather than the number of information channels, lessening mutual interferences between crowded users and downing a cost for fabricating a system.

### TECHNICAL FIELD

The invention relates to a code-select code-division multiple-access modulation/demodulation method and the device thereof, and more particularly to a method of CS/CDMA (Code-Select Code-Division Multiple Access) spreading by one out of a set of orthogonal spreading codes. It further advances functional features of PW/CDMA (Pulse-Width CDMA) and MP/CDMA (Multi-Phase CDMA), which have been used to overcome problems rising from an increase of signals levels of modulation signals with multi-code in accordance with an increase of the number of transmission data channels in a conventional DS/CDMA (Direct-Sequence CDMA) scheme.

### BACKGROUND ART

Conventional techniques for wireless transmission multiplication are usually classified into frequency-division multiple-access (FDMA), time-division multiple-access (TDMA), and code-division multiple-access (CDMA).

Although complicate in implementing a practical system therewith, the CDMA becomes the standard of the world rather than the TDMA that has competed with the CDMA during the second generation mobile communication market in considering the third generation mobile communication, e.g., IMT-2000.

The CDMA, as the world standard of mobile communication nowadays, transmits signals of plural channels after linearly summing them, that is, a DS/CDMA form that spreads bandwidths by directly multiplying data with orthogonal codes. Therefore, the number of output signal levels increases along the number of channels, resulting in a more complex structure of a system as instant amplitude fluctuation is large like an analogue signal.

Moreover, while it is less complicated for a terminal of the second generation mobile communication system because the terminal uses only one orthogonal code though, but for at a base station, the next generation mobile communication system may confront to many difficulties in implementation because higher data rates for users needs to employ a multi-code form that conducts multiple orthogonal codes even at a terminal for one user.

FIG. 1 shows a structure of a conventional DS/CDMA transmitter, explaining a procedure of the conventional DS/CDMA with its problems.

As shown in FIG. 1, input data signals D1, D2, . . . , Dn are multiplied by orthogonal codes C1, C2, . . . , Cn at multipliers 1a, 1b, . . . , 1n, respectively. All the multiplied values are summed in analogue summator 100, and then converted into an analogue signal S1 containing N+1 levels. The analogue signal S1 is transferred to a RF (Radio Frequency) amplifier (not shown).

That is, in the conventional DS/CDMA system, the sum of information of multiple channels is transmitted via a single frequency at the same time, after multiplying each channel data by unique orthogonal code that has tens or thousands times higher rate that of data not to interface each other due to the orthogonality of each code.

Then, at a receipt terminal, after receiving such transferred signals, the received signals are multiplied by codes identical to the orthogonal codes used in the desired channels at the transmission step, and makes desirable channel information left therein while undesirable channel information vanished.

However, in the conventional DS/CDMA scheme, there is a problem of an increase of modulated signal levels along the number of usable orthogonal codes, causing a construction of a system to be complicate and a signal processing to be difficult.

There has been proposed a PW/CDMA (Pulse-Width CDMA) scheme in Korean Patent No. 0293128 (issued on Mar. 30, 2001), as one of solutions to overcome the complexity of system and the difficulty of signal processing involved in the DS/CDMA system. In the PW/CDMA, signal portions beyond a predetermined level on modulation signals are truncated (or clipped) and the rest portions are converted into a dimension of pulse width. Signal waveforms by the PW/CDMA are always maintained in binary forms.

FIGS. 2 and 3A˜3C show a construction of a conventional PW/CDMA transmitter and waveforms modulated therein, respectively. It will be explained about an operation of the PW/CDMA and its problems.

As shown in FIG. 2, a level limiter 210 truncates signal portions beyond a predetermined level from an output signal of a digital summator 200 instead of the analogue summator 100 employed in the DS/CDMA, and thereafter a pulse generator 220 makes a modulation signal S2 of binary form as shown in FIG. 3A.

The method of PW/CDMA, even while able to generate binary modulation signals, has a demerit that a bandwidth of a modulation signal increases in proportion to the number of levels when the number of levels of the modulation signal beyond a predetermined level is larger than 2.

A multi-phase CDMA (MP/CDMA) system has been introduced in Korean Patent Application 2001-8044 filed on Feb. 17, 2000, transferring CDMA signals in the form of multi-code as well as eliminating the former defects.

FIG. 4 shows a module construction of a conventional MP/CDMA transmitter. Referring to FIG. 4, it describes about an operation of the MP/CDMA and the shortness thereof.

It is different from the feature of FIG. 2 that truncated signals by means of a level limiter 400 are converted into a dimension of phase in a phase converter 410 instead of the pulse generator 220. The converted modulation signal with the phase dimension is transferred to the RF amplifier.

As stated above, the PW/CDMA schemes simplifies signal waveforms but has an increasing bandwidth of a modulation signal in proportion to the number of levels when the number of the rest levels of the modulation signal after truncating the signal portions beyond the predetermined level is larger than 2. On the other hand, the MP/CDMA overcomes the increasing bandwidth of a modulation signal, in which the rest levels after the truncation are converted into a dimension of phase with a RF signal not being converted into a dimension of pulse width.

The aforementioned methods, PW/CDMA and MP/CDMA, assign orthogonal codes to information channels each by each as the DS/CDMA does, while simplify a construction of a system by preventing an increase of an signal level of a DS/CDMA-type signal level that is truncated by a portion beyond a predetermined level.

As a result, as the assignment of one orthogonal code to one data channel in the former DS/CDMA, PW/CDMA, and MP/CDMA accompanies with such that the number of orthogonal codes is identical to that of data channels, an increase of the data channels causes increases of the orthogonal codes and of levels of transmission signals modulated. And, the orthogonality of the orthogonal codes may be corrupted during the truncation operation, causing the transmission signals to be sensitive to mutual interferences between signals transferred therethrough. Thus, it needs to provide a new modulation/demodulation technique capable of reducing the number of orthogonal codes used therein while with employing multiple codes, in order to enhance a transmission speed.

### DISCLOSURE OF INVENTION

The present invention, being prepared to solve the aforementioned problems, objects to provide a method of modulating and demodulating signals in a code-select code-division multiple access system, in which orthogonal codes are assigned to blocks not allocating them to data channels each by each and selected by transmission data values.

It is another object of the present invention to reduce the number of orthogonal codes, to lessen degradation of orthogonality between the orthogonal codes due to truncation for creating PW/CDMA and MP/CDMA signals, and to reduce mutual interferences between modulation signals with lessened orthogonality, in order to solve a problem that a modulation signal generated from a conventional DS/CDMA procedure is settled in the form of analogue signal having various levels like a video signal because of signal levels more one than the number of data channels transferred.

A method of modulating and demodulating conductive in a code-division multiple access system, comprises the steps of: generating orthogonal codes to maintain orthogonality between information channels; grouping the orthogonal codes into blocks with a unit number of 2^{N} (N is a positive integer); allocating information channels, in number of N+1, to each of the blocks; and selecting an alternative one of the 2^{N} orthogonal codes by means of data signals of the N information channels among the allocated information channels and modulating data signals of the N+1 information channels by multiplying the selected orthogonal code with a data signal of the rest one of the information channels. Additionally subsequent to those procedures, it is preferred to conduct the following steps of: summing signals modulated from the blocks in a digital summator to generate a multilevel signal; truncating signals portions of the multi-level signal, the signal portions being beyond a predetermined level; and converting the truncated multi-level signal into a dimension of pulse width by means of a PW/CDMA process, or converting the truncated multi-level signal into a dimension of phase by means of an MP/CDMA process.

The modulated signal is demodulated by the steps of: synchronizing the modulated signal with an orthogonal code provided from an internal orthogonal code generator; detecting an orthogonal code, which has the maximum one of absolute correlation values between the synchronized signal and the orthogonal codes from the internal orthogonal code generator, as an orthogonal code used an orthogonal code used per the block; and restituting a data signal of the orthogonal code selected during the modulation, by means of a correlation value of the detected orthogonal code and a data signal of an information channel used for selecting the orthogonal code during the modulation.

Meanwhile, the modulation for a code-division multiple access system is accomplished by a modulator comprises: an orthogonal code blocking unit for grouping orthogonal codes in number of 2^{M-1} when the number of the information channels is M (M is a positive integer); an orthogonal code selector for designating an alternative one of the 2M−1 orthogonal codes by means of data signals of information channels in number of M−1 among the M information channels; and a code converter for multiplying the selected orthogonal code with a data signals of the rest one except the M−1 information channels.

And, the modulated signal by the modulator for the code-division multiple access system is demodulated by a demodulator including: a receipt signal synchronizer for according the modulated signal with an orthogonal code provided from an internal orthogonal code generator; an orthogonal code detector for finding out an orthogonal code used in modulating by means of the maximum absolute value of correlation values between the synchronized signal and orthogonal codes; and a data abstracter for restituting a data signal of an information channel used in selecting an orthogonal code, by means of the detected orthogonal code, and for restituting a data signal of an information channel used in demodulating, by means of a correlation value of the used orthogonal coded.

### BRIEF DESCRIPTION OF THE DRAWINGS

FIG. 1 is a constructive diagram of a conventional DS/CDMA (Direct-Sequence CDMA) transmitter.

FIG. 2 is a constructive diagram of a conventional PW/CDMA (Pulse-Width CDMA) transmitter.

FIGS. 3A through 3C are schematic diagrams illustrating a procedure converting levels of a DS/CDMA signals into a dimension of pulse widths of a PW/CDMA signal.

FIG. 4 is a constructive diagram of a conventional MP/CDMA (Multiple-Phase CDMA) transmitter.

FIG. 5 is a schematic diagram illustrating a procedure for generating orthogonal codes by means of Maximal sequence.

FIG. 6 is a constructive diagram of a CS/CDMA modulator for modulating data with orthogonal codes segmented into blocks.

FIG. 7 is a constructive diagram of a CS/CDMA demodulator according to the invention.

FIG. 8 is a constructive diagram of a data abstracter of the CS/CDMA demodulator according to the invention.

FIG. 9 is a schematic diagram illustrating an example of transmitting the orthogonal codes with various speeds in a backward direction.

FIGS. 10A and 10B are functional block diagrams of CS/CDMA modulation/demodulation devices according to the invention.

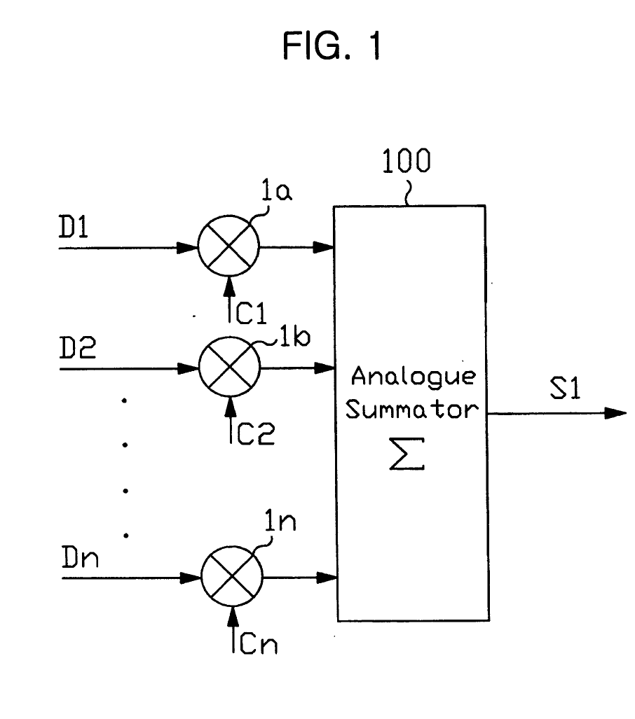

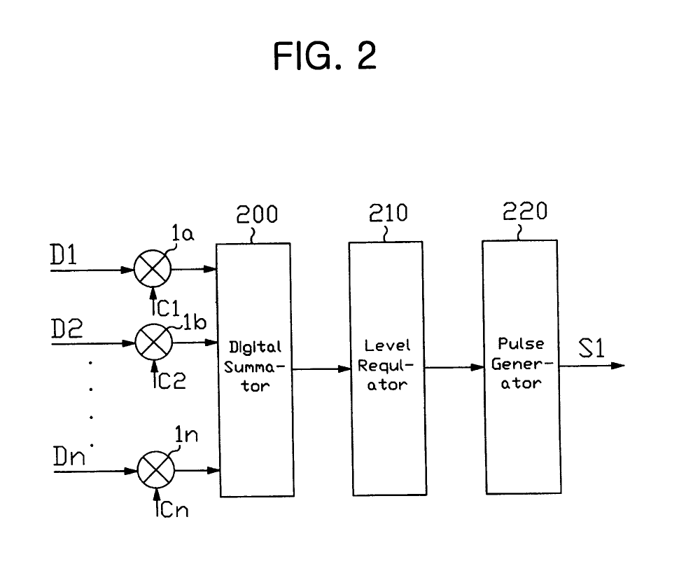

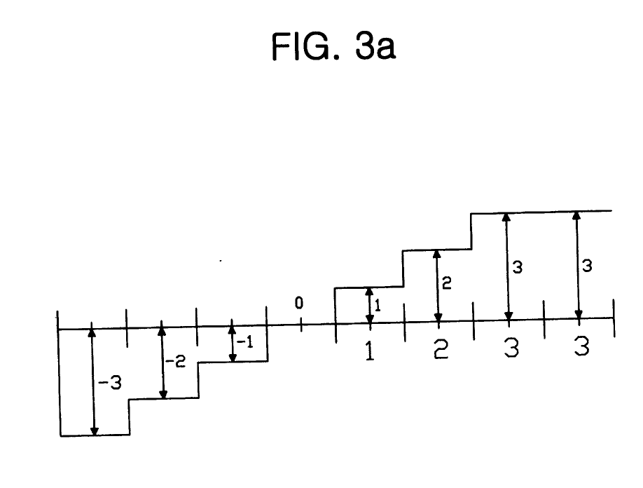

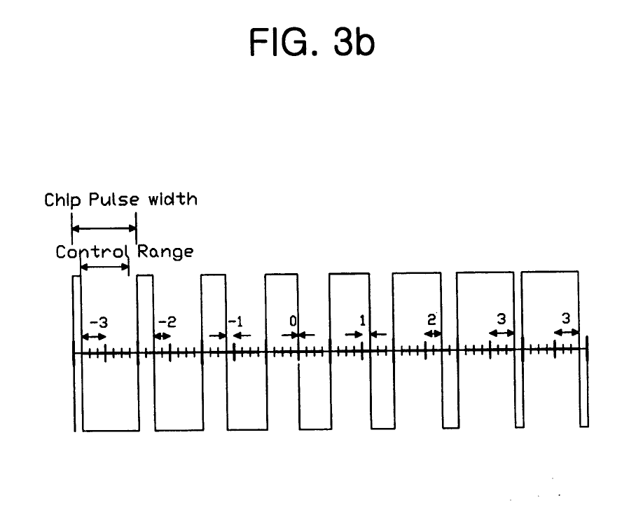

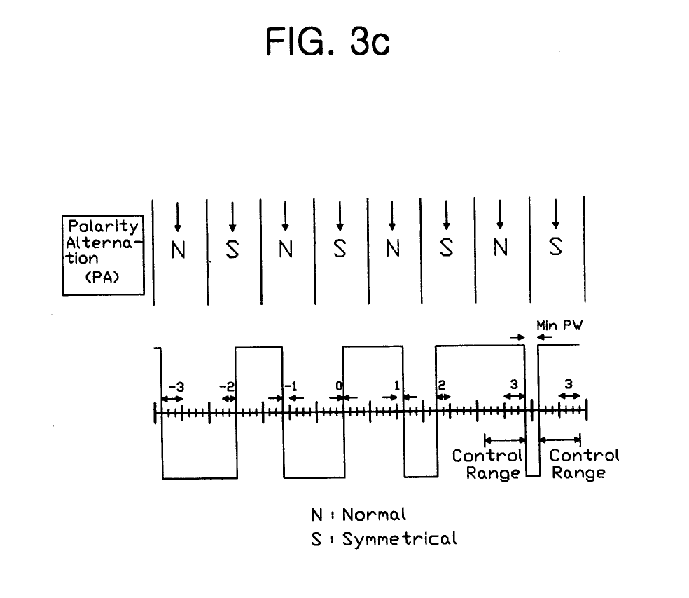

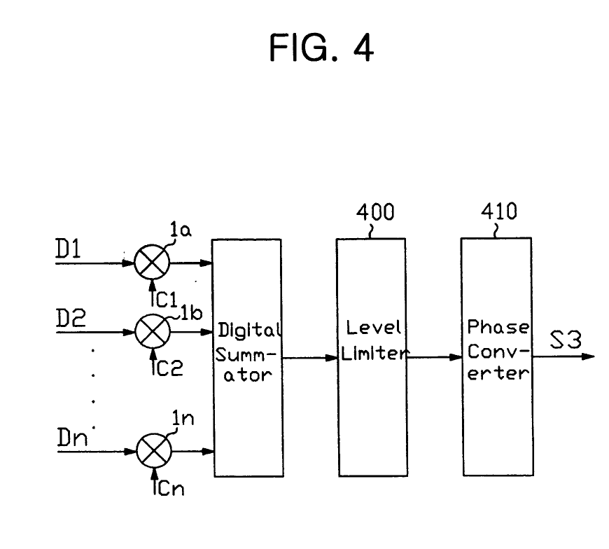

### BEST MODE FOR CARRYING OUT THE INVENTION

Now it will be explained about the preferred embodiments of the present invention in conjunction with the accompanying drawings to understand the present invention. The embodiments of the present invention may be modified or practiced into various features, and the scope of the invention may not be limited in the following embodiments. The embodiments of the present invention are provided to those skilled in the art for a thorough understanding about the present invention

The basic solution of the present invention is to reduce the number of usable orthogonal codes by sending information loaded on orthogonal codes that are directly selected with data held in information channels not assigning the orthogonal codes to the information channels each by each.

By applying the basic solution thereto, it is possible to free from inefficient activation with entire orthogonal codes due to mutual interferences between plural users, and from lessened orthogonality of the orthogonal codes due to excessive truncation.

Furthermore, using one orthogonal code in the unit of a primary user reduces the mutual interference appearing when signals are gathering from plural users at a base station in the environment of PW/CDMA or MP/CDMA.

And, regarding the number of available orthogonal codes was substantially less than half of those created due to the mutual interferences between users, the present manner for CS/CDMA modulation/demodulation enables all of orthogonal codes, which have not been utilized so far, to be employed fully therein.

While it is preferred to apply the orthogonal codes of the invention to a CDMA code sequence generation system proposed in Korean Patent No. 10-087083-000 (issued on Jul. 20, 1995) as an example, which does not limit application of the orthogonal codes embodied in the present invention. Hereinafter, the orthogonal code specified in the issued patent is referred to “CASUH” code in the following description.

In utilizing the code sequence generation system for the CS/CDMA procedure according to the present invention, it is available to synchronize signals by means of a correlator because a correlation value of a code sequence is always set on “0” that renders good orthogonality notwithstanding an increase of the number of users.

In addition, immunities to the mutual interferences between user channels contribute to prevent degradation of transmission quality, so that performance of the CDMA system is enhanced outstandingly.

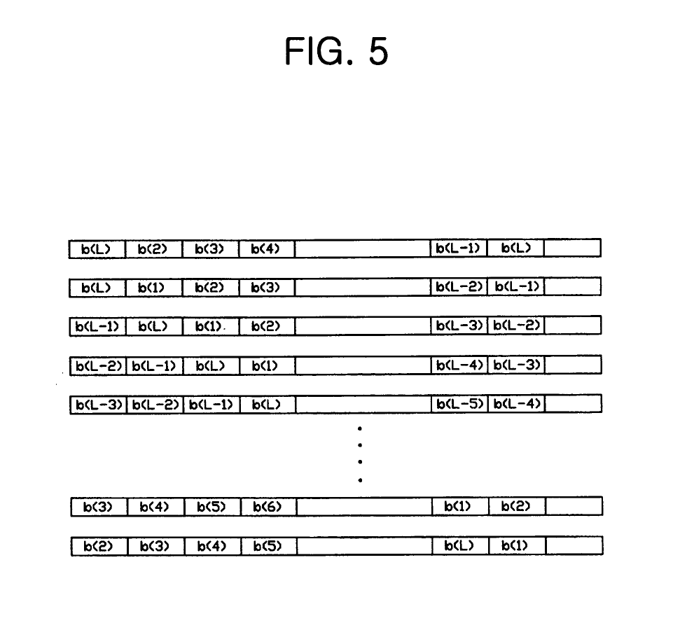

FIG. 5 figures a procedure for generating orthogonal codes by means of a maximal sequence. Referring to FIG. 5, it will be described about the procedure of generating orthogonal codes by using the maximal sequence.

The autocorrelation characteristics in the maximal sequence are summarized in Equation I as follows:

Ci(t)Ci(t+τ)dt=L, when τ=0; and

Ci(t)Ci(t+τ)dt=−1, when τ 0, [Equation I]

where Ci(t) is a code value on the maximal sequence; and L is the number of codes (code length, or code period) on the maximal sequence.

With reference to Equation I, when a time difference between codes is over than 1 chip (or bit), the autocorrelation value always becomes −1. It causes from the fact that the number of “0” is less than the number of “1” by one on the maximal sequence.

Therefore, as shown in FIG. 5, codes in number of L are made by shifting chips of the maximal sequence by one chip and by returning the last chip to the first location. After then, appending “0” to all codes of L at their rear chip positions modifies the L-numbered codes to have good orthogonality with code length of L+1 chips. The following Equation II represents the correlation characteristics involved in the code length L+1:

Ci(t)Ci(t+τ)dt=L+1, when τ=0; and

Ci(t)Ci(t+τ)dt=0, when τ 0, [Equation II]

where Ci(t) is CASUH code.

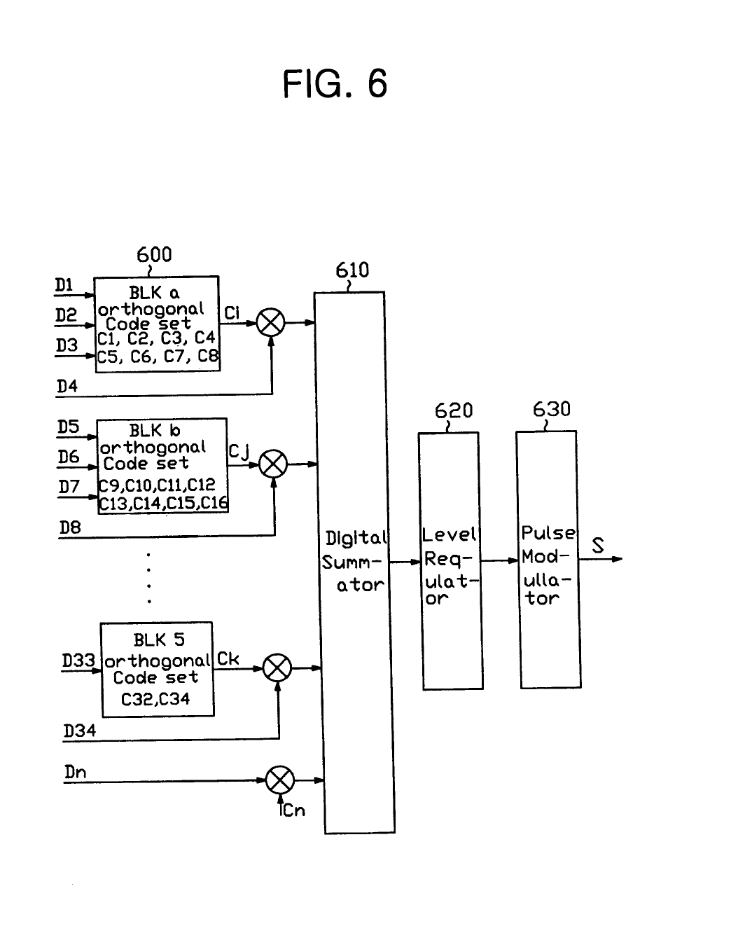

FIG. 6 illustrates a construction of a CS/CDMA modulator for modulating data with orthogonal codes segmented into blocks 600 of BLKa, BLKb, . . . , BLKf.

Referring to FIG. 6, an alternative one of orthogonal codes C1˜C8 is selected in the orthogonal code block BLKa in response to data signals D1˜D3 of information channels. The selected orthogonal code Ci is multiplied by data signal D4 in an exclusive-OR operation. The result from the exclusive-OR loop is applied to a digital summator 610.

As same as the manner in the block BLKa, other orthogonal codes are selected in their correspondent blocks in response to data signals assigned thereto. Namely, orthogonal codes Cj (among C9˜C16) and Ck (among C33 and C34) are selected in the blocks BLKb and BLKf, and multiplied by data signals D5˜D8 and D34, respectively. As a result, orthogonal codes are generated with modulated patterns from their corresponding blocks assigned to Ci through Ck respectively. The orthogonal codes modulated by the blocks are converted into a multilevel signal by the digital summator 610. A level limiter 620 that clips signal portions beyond a predetermined level as done in the process of PW/CDMA or MP/CDMA truncates the multi-level signal from the digital summator 610. The truncated signal by the level limiter 620 is converted into a final multi-level signal, by a pulse modulator 630, whose levels are figured out with predetermined pulse widths or phases.

As represented in FIG. 6, a data signal Dn as the last information channel, even though not associated with an orthogonal code block, can be modulated with an orthogonal code, e.g., Cn, as a conventional CDMA scheme does.

It may be seen from FIG. 6 that the number of orthogonal codes generated from all of the blocks BLKa˜BLKf is less than that by other CDMA systems.

The CS/CDMA scheme of the invention enables the architecture of a terminal to be simplified since one orthogonal code containing multiple levels is enough to convey information channels, without transmitting multiple codes to enhance transmission speeds.

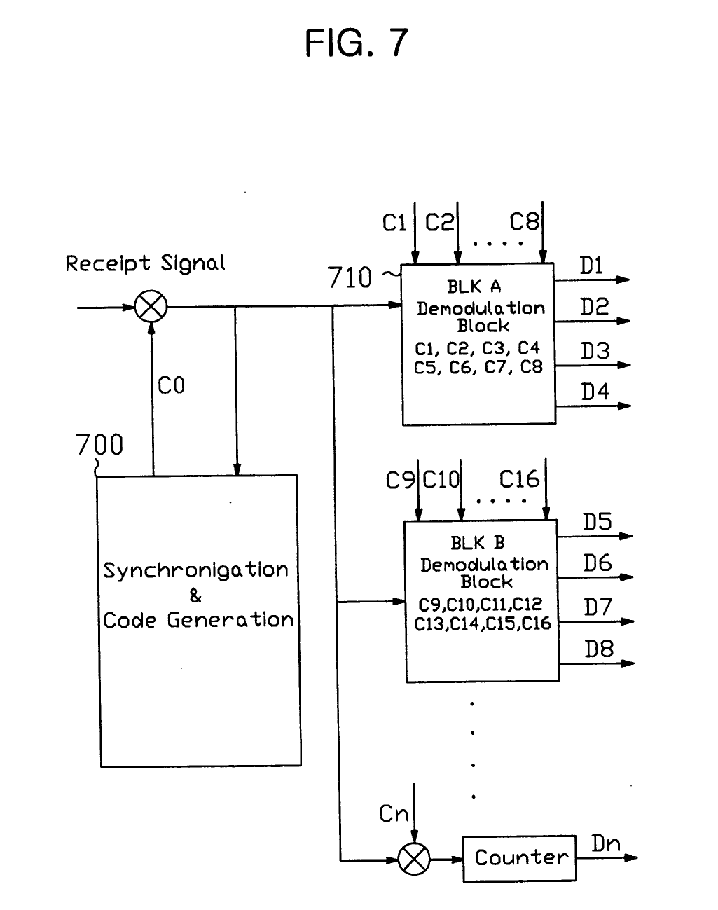

FIG. 7 shows a construction of a CS/CDMA demodulator according to the present invention.

In demodulating data on the sequence of CS/CDMA system according to the invention, referring to FIG. 7, a code generator 700 creates orthogonal codes after receiving modulated signals from a transmission terminal and synchronizing them by the same manner with a conventional CDMA process.

The orthogonal codes are transferred to demodulation blocks 710. The demodulation blocks 710 each find out orthogonal codes used in modulating at the former step, and then demodulate original data, which have been modulated, by means of the used orthogonal codes. While FIG. 7 illustrates such that all demodulation blocks took part in the demodulation process, it is general that the demodulation blocks are conductive one by one. More detailed explanation about the process of demodulating data is following.

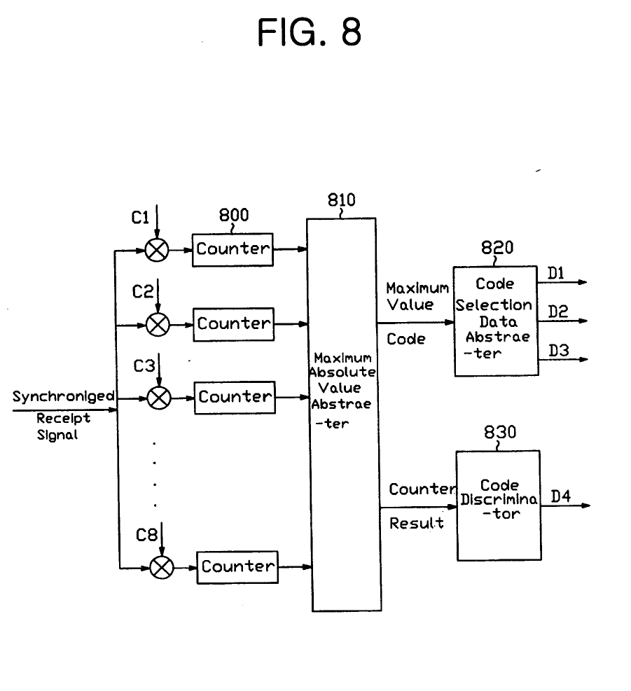

FIG. 8 shows a functional construction of data abstracters embedded in the demodulation block of FIG. 7.

Referring to FIG. 8, after eight orthogonal codes C1˜C8 are multiplied by the receipt signal, counters 800 carries out correlation operations with the multiplied orthogonal codes. A maximum absolute value abstracter 810 detects an orthogonal code that has the largest absolute value among the eight correlation values provided from the counters 800, and then transfers it to a code selection data abstracter 820.

The code selection data abstracter 820 finds out data signals D1˜D3 those are employed in selecting the orthogonal code of the largest absolute value. A code discriminator 830 demodulates the value of a data signal D4 with reference to a code relevant to the correlation value of the orthogonal code containing the maximum absolute value. As like those sequences, each demodulation block of FIG. 7 demodulates its corresponding data signals.

It is possible to conduct a demodulation process by a conventional scheme for information channels of the orthogonal code blocks shown in FIG. 6, each of the blocks being assigned to single orthogonal code,.

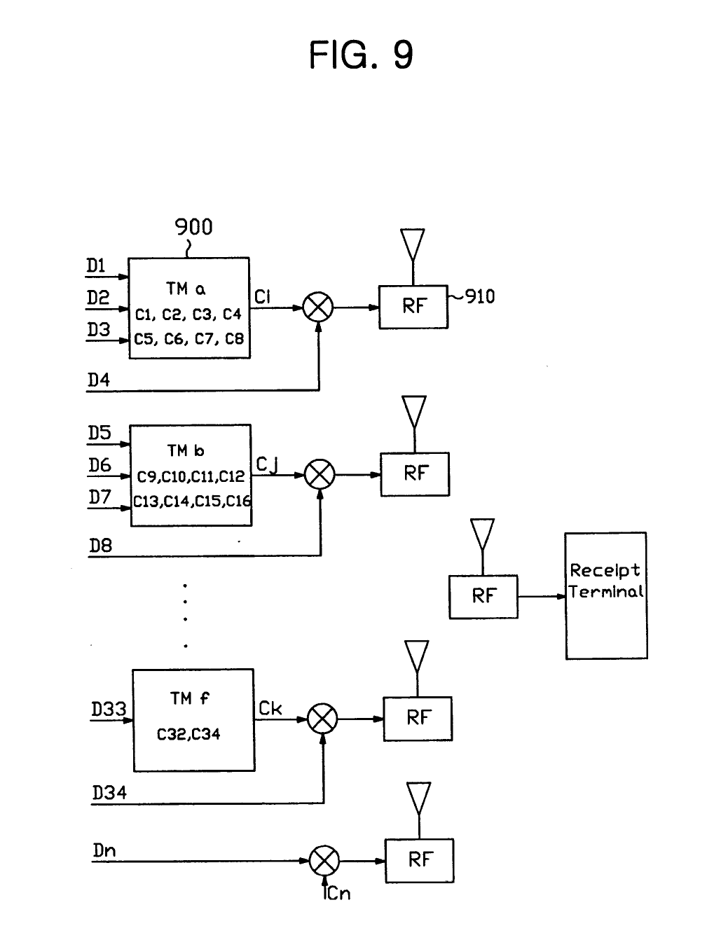

FIG. 9 illustrates a practical example of a wireless communication system (e.g., operable in the bandwidth of 5 MHz) with the present invention, in which signals are operable with various transmission speeds in a backward direction (from a terminal to a base station).

In FIG. 9, the orthogonal code blocks of FIG. 6 are each settled in terminals 900 (TMa˜TMf) and signals from the terminals are transferred to a base station simultaneously through a wireless network. There may occur mutual interferences between the terminals because the orthogonal code signals Ci˜Cf are independently applied to the base station while those in FIG. 6 are applied thereto with being summed and modulated.

However, since the orthogonal code signals from the terminal are transferred to the base station one by one and there are no corruptions on the orthogonality of the codes, the demodulation process shown in FIG. 8 is practically adaptable to a receipt terminal of the base station.

As each information channel permits to transfer its signals at the speed of 32 Kbps (kilo-bits per second), the terminal (e.g., TMa) is associated with four information channels and sends a signal through a transmitter 910 at 128 bps. At this time, it needs eight orthogonal codes.

The eight orthogonal codes for the CS/CDMA system would be regarded as not economical rather than four orthogonal codes those are enough to the procedure of other CDMA systems. However, while conventional CDMA systems use four orthogonal codes all of which are fully modulated, the present CS/CDMA just modulates a selected one of orthogonal codes. Thereby, waveforms of modulated signals are established in a binary pattern even though with multiple codes, which lets a RF amplifier be operable without linearity. And, it is possible to demodulate the modulated signals by processing binary signals at a receipt terminal, which simplifies architecture of a system.

As same as the procedure with the terminal TMa, the terminal TMb also outputs one orthogonal code, and the terminal TMf generates one orthogonal code at a transmission speed of 64 bps while the number of orthogonal codes is the same with that of the conventional one.

With respect to the fact of mutual interferences between signals simultaneously transferred to the base station from the plural terminals, the smaller number of orthogonal codes than that of the conventional DS/CDMA system is helpful to reduce the mutual interferences. In addition, the orthogonality involved in the truncation is less degraded than the case of the PS/CDMA or the MP/CDMA, which enhances demodulation performance at the receipt terminal.

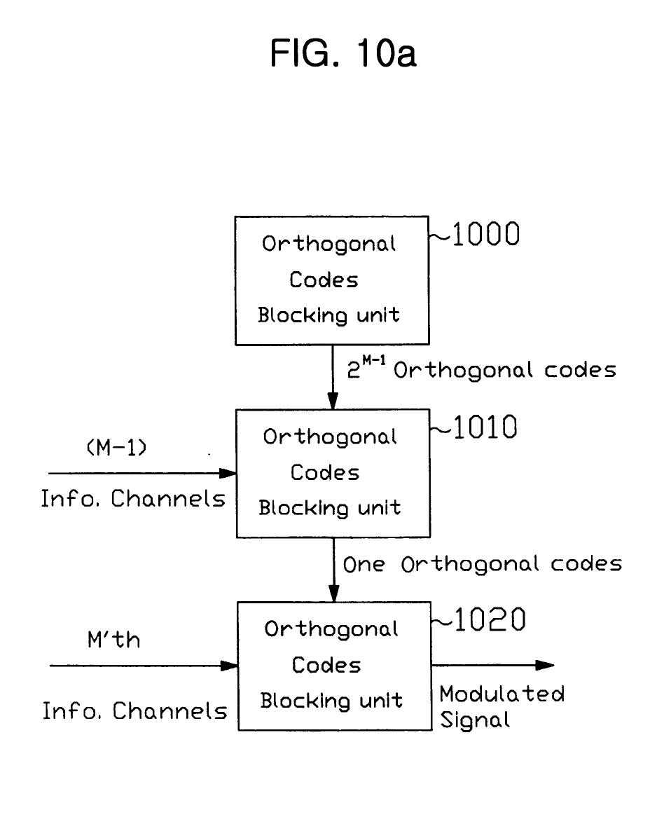

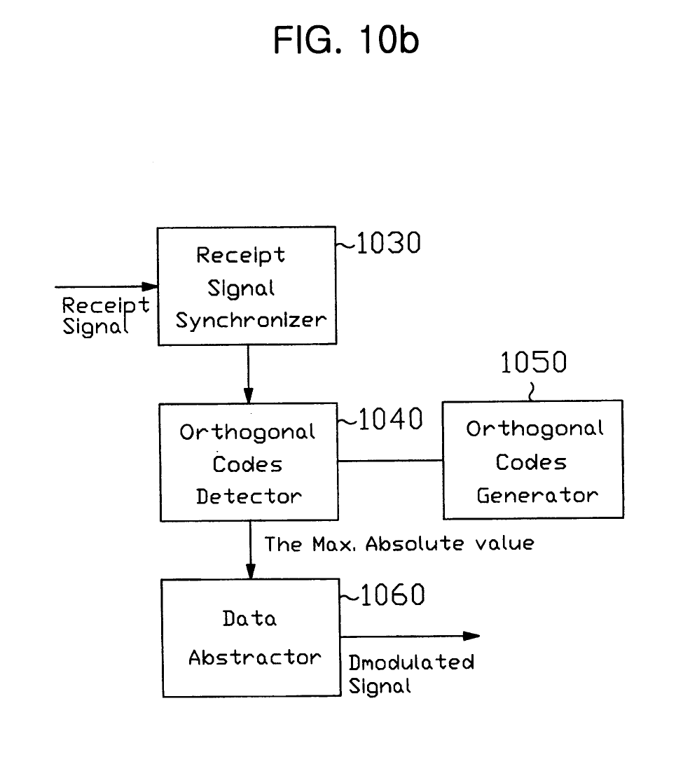

FIGS. 10A and 10B illustrate functional constructions of a modulator and a demodulator, for conducting the CS/CDMA scheme according to the present invention.

First, referring to FIG. 10A, the modulator of the CS/CDMA system includes an orthogonal code blocking unit 1000, an orthogonal code selector 1010, and a code converter 1020.

Assuming that the number of information channels is M, the orthogonal code blocking unit 1000 groups orthogonal codes in number of 2^{M-1} and the orthogonal code selector 1010 selects an alternative one of the 2^{M-1} orthogonal codes by using data assigned to the M−1 information channels. The code converter 1020 receives the selected orthogonal code from the selector 1010, and then converts it into a modulated signal by multiplying the selected orthogonal code with data of the rest one (i.e., the M'th information channel) except the M−1 information channels.

The demodulator of the CS/CDMA system, referring to FIG. 10B, includes a receipt signal synchronizer 1030, an orthogonal code detector 1040, an internal orthogonal code generator 1050, and a data abstractor 1060.

The receipt signal is supplied through a RF receiver (not shown) and then applied to the synchronizer 1030. The synchronizer 1030 accords the receipt signal with an orthogonal code provided from the internal orthogonal code generator 1050. The receipt signal synchronized to the orthogonal code of the generator 1050 is applied to the detector 1040.

The detector 1040 calculates absolute values of correlation between the synchronized receipt signal and orthogonal codes, and then finds out an orthogonal code that has been employed in modulating an orthogonal code having the maximum among the absolute values. The detected orthogonal code is transferred to the data abstractor 1060.

The data abstractor 1060 restitutes data of an information channel used in selecting an orthogonal code by means of the detected orthogonal code, and data of an information channel used in demodulating an orthogonal code by means of a code of a correlation value involved in a used orthogonal code.

In the aforementioned description, several specific details are set forth in order to provide a thorough understanding of the present invention. It should be understood that the description of the preferred embodiment is merely illustrative and that it should not be taken in a limiting sense.

In accordance with the detailed described above, the present invention reduces the number of orthogonal codes as compared with the number of information channels, so that it is effective to lessen mutual interferences between crowded users.

As one orthogonal code is available to be transferred and a transmission signal always maintains a binary pattern, in the condition with multiple codes to enhance a transmission speed at a user's terminal, a RF amplifier in the terminal needs not to be equipped with linearity and power efficiency in the terminal is promoted thereby. And, a performance of a system is enhanced, because orthogonality of the orthogonal codes is not corrupted due to truncation and thereby mutual interferences are lessened even when plural signals are being transferred at the same time.

In addition, the binary waveforms of signals enable RF parts developed for conventional TDMA system to be applicable to a CDMA system, providing easiness in supplying parts. And, it is possible to demodulate signals only with binary signal processing, simplifying hardware architecture of a system with a lower fabrication cost.

1. A method of processing code-division multiple access, comprising the steps of:
(a) generating orthogonal codes to maintain orthogonality between information channels;
(b) grouping the orthogonal codes into blocks with a unit number of 2^{N} (N is a positive integer);
(c) allocating information channels, in number of N+1, to each of the blocks; and
(d) selecting an alternative one of the 2^{N} orthogonal codes by means of data signals of the N information channels among the allocated information channels and modulating data signals of the N+1 information channels by multiplying the selected orthogonal code with a data signal of the rest one of the information channels.

2. The method of claim 1, further comprising, after the step (d), the steps of:
summing signals modulated from the blocks in a digital summator to generate a multi-level signal;
truncating signals portions of the multi-level signal, the signal portions being beyond a predetermined level; and
converting the truncated multi-level signal into a dimension of pulse width by means of a PW/CDMA process, or converting the truncated multi-level signal into a dimension of phase by means of an MP/CDMA process.

3. The method of one of claims 2 and 3, wherein the modulated signal at the step (d) is demodulated by the steps of:
synchronizing the modulated signal with an orthogonal code provided from an internal orthogonal code generator;
detecting an orthogonal code, which has the maximum one of absolute correlation values between the synchronized signal and the orthogonal codes from the internal orthogonal code generator, as an orthogonal code used an orthogonal code used per the block; and
restituting a data signal of the orthogonal code selected during the modulation, by means of a correlation value of the detected orthogonal code and a data signal of an information channel used for selecting the orthogonal code during the modulation.

4. The method of claim 1, wherein the modulation for the code-division multiple access is accomplished by a modulator comprising:
an orthogonal code blocking unit for grouping orthogonal codes in number of 2^{M-1} when the number of the information channels is M (M is a positive integer);
an orthogonal code selector for designating an alternative one of the 2M−1 orthogonal codes by means of data signals of information channels in number of M−1 among the M information channels; and
a code converter for multiplying the selected orthogonal code with a data signals of the rest one except the M−1 information channels.

5. The method of claim 4, wherein the modulated signal by the modulator for the code-division multiple access is demodulated by a demodulator comprising:
a receipt signal synchronizer for according the modulated signal with an orthogonal code provided from an internal orthogonal code generator;
an orthogonal code detector for finding out an orthogonal code used in modulating by means of the maximum absolute value of correlation values between the synchronized signal and orthogonal codes; and
a data abstracter for restituting a data signal of an information channel used in selecting an orthogonal code, by means of the detected orthogonal code, and for restituting a data signal of an information channel used in demodulating, by means of a correlation value of the used orthogonal coded.
